(19) United States
(12) Patent Application Publication
(10) Pub. No.: US 2003/0223313 A1
(43) Pub. Date: Dec. 4, 2003

(54) Time zone setting device

(76) Inventor: Keng Kuei Su, Chien District (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/155,080

(22) Filed: May 28, 2002

(51) Int. Cl. G04B 19/22

(52) U.S. Cl. 368/21

(57) ABSTRACT

A time zone setting watch includes a case with a dial and a circuit board received therein. A display device is located on the dial and an input device is connected to the dial and accessible from outside of the case. A CPU and a memory for storing information of various time zones are connected to a circuit board in the case. A clock generating device and a quartz oscillator are connected to the circuit board, which are operated by buttons on the case of the watch. The user may input instructions by using the buttons to pick a specific information in the memory so as to display the correct time and zone in the display device.

### FIELD OF THE INVENTION

The present invention relates to a watch that includes a memory and a control device so as to set date and time of different time zones.

### BACKGROUND OF THE INVENTION

A conventional watch is designed for showing time and date for the users. However, only the information of one time zone can be shown and this is not ,satisfied by the users especially for those who travel a lot. The conventional watch has to be adjust the time and date when he/she travels from one place to another. A reverse operation action is proceeded after the user travels back to the original place. In addition, the user has to memorize several time laps of the time zones so as to adjust the watch.

The present invention intends to provide a watch that has an operation panel connected to a memory and a CPU so that the correct time and date of a desired zone can be shown on the watch.

### SUMMARY OF THE INVENTION

In accordance with one aspect of the present invention, there is provided a time zone setting watch which comprises a case with a dial and a circuit board received therein. A display device and an input device are located on the dial. The input device including buttons is accessible from outside of the case. A clock generating device and a quartz oscillator are connected to the circuit board. A CPU is connected to the circuit board, the clock generating device, the quartz oscillator, and the display device. A memory is connected to the circuit board and the CPU. A power supplies electric power to the circuit board, the display device, the input device, the clock generating device, the quartz oscillator, the CPU and the memory.

The primary object of the present invention is to provide a watch that has buttons which is operated to activate the CPU to display time and date of a specific time zone.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the time zone setting watch of the present invention;

FIG. 2 is function block diagram of the time zone setting watch of the present invention, and FIG. 3 shows the circuit of the time zone setting watch of the present invention.

### DETAILED DESCRIPTION OF THE PREFERRED EMBODIMENT

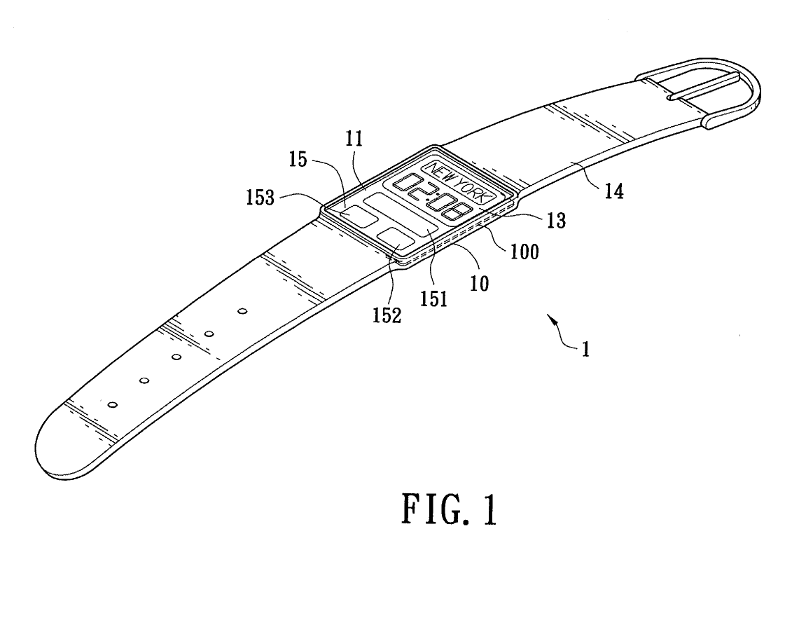

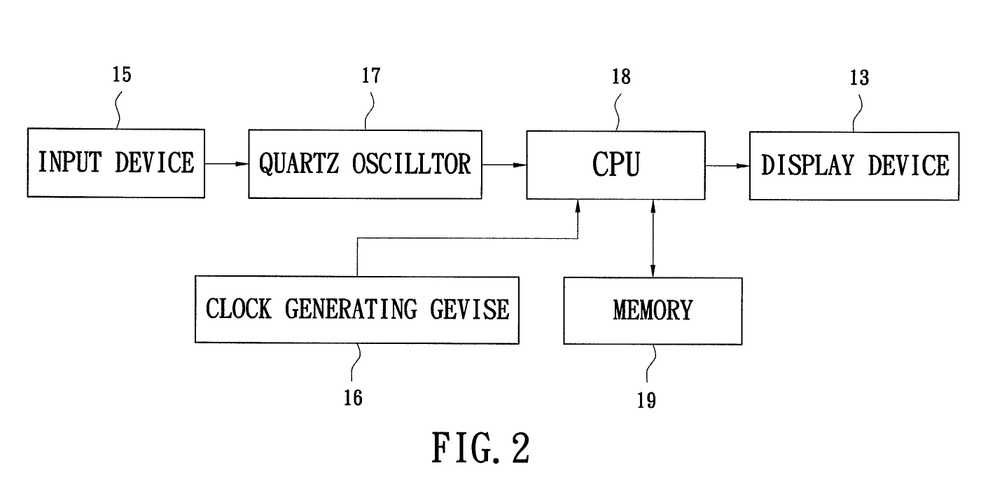

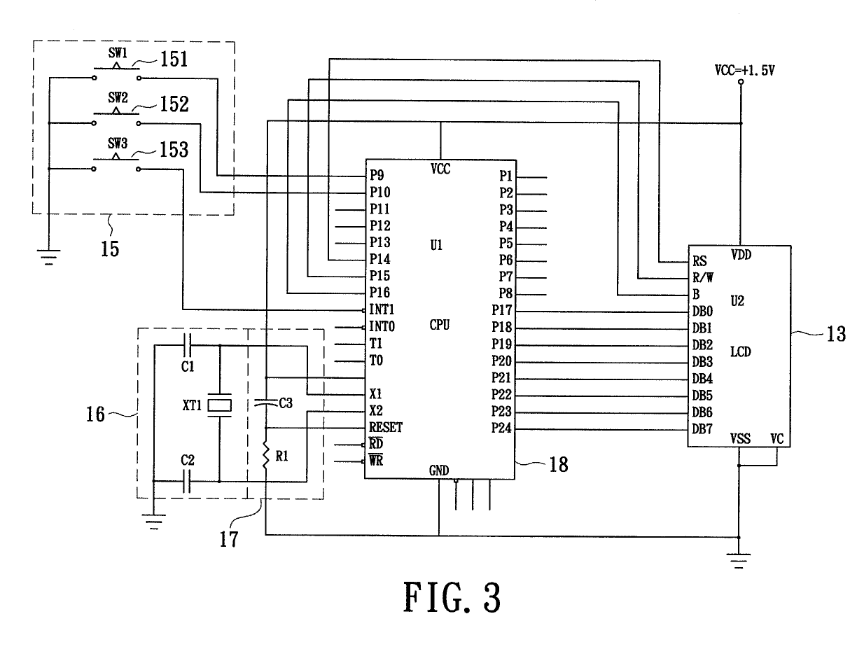

Referring to FIGS. 1 and 2, the time zone setting watch 1 of the present invention comprises a case 10 with a dial 11 and a circuit board 100 received in the case 10. A display device 13 is located on the dial 11 and includes several windows to show different information such as date and time. A watchband 14 is connected to the case 10 such that the watch 1 can be worn on the user's wrist.

An input device 15 is connected to the dial 11 and includes an option button 151, an adjust button 152, and a confirm button 153 on the surface of the watch. The three buttons 151, 152 and 153 are accessible from outside of the case 10.

A clock generating device 16 is connected to the circuit board 100 and provides clock information to a CPU 18 connected to the circuit board 100. A quartz oscillator 17 and a memory 19 are connected to the circuit board 100 wherein the memory 19 stores information of different time zones. The CPU 18 is connected to the circuit board 100, the clock generating device 16, the quartz oscillator 17, and the display device 13. A power supply (not shown) is connected to the circuit board 100, the display device 13, the input device 15, the clock generating device 16, the quartz oscillator 17, the CPU 18 and the memory 19.

As shown in FIG. 3, the quartz oscillator 17 is connected to the display device 14, and the CPU 18 is connected to the clock generating device 16, the quartz oscillator 17 and the display device 13. The memory 10 is connected to the CPU 18.

A instruction signal is sent to the CPU 18 by operating the input device 15 and the quartz oscillator 17 picks the signal from the input device 15 to the CPU 18 which picks specific information in the memory 19 and the picked information is displayed in the display device 13. In addition, the CPU 18 picks the information of the clock generating device 16 and the information in the memory 19, calculates the two information and displays the correct time and date of the time zone of the chosen city or country.

The user may choose alarm mold, present time mold, or country or city mold by using the option button 151. The CPU 18 is then activated to display the chosen information on the display device 13. The adjust button 152 is used to input an adjust signal to the CPU 18 to adjust the information of the alarm, the present time, or country or city. Every time a signal is sent to the CPU 18, the confirm button 153 has to be pressed to switch another mold.

When the alarm mold is set by operating the option button 151 and choosing the information displayed in the display device 13, the confirm button 153 is pressed. The digits on the display device 13 is flashing and then the adjust button 152 is pressed to change the digits. The confirm button 153 is pressed again to set the digits. By the process, the digits on the display device 153 can be set one by one.

The present time can be adjusted by first pressing the option button 151 to choose the present time mold. The digits are flashing one by one and changed by pressing the adjust button 152. The flashing digits are set by pressing the confirm button 153.

The country or city mold can be chosen by using the option button 151 and the CPU 18 provides names of country and city from the memory 19 to be chosen in the display device 13. The alphabets are flashing and can be adjusted by using the adjust button 152 and be set by using the confirm button 153. When the country or city is chosen, the corresponding time and date of that country or city are shown in the display device 13. Therefore, the user may switch the time and date from one place to another by simply using the buttons 151 to 153 on the case 10.

While we have shown and described the embodiment in accordance with the present invention, it should be clear to those skilled in the art that further embodiments may be made without departing from the scope of the present invention.

What is claimed is:

1. A time zone setting watch comprising:
a case with a dial received therein and a circuit board received in the case, a display device located on the dial;
an input device connected to the dial and accessible from outside of the case;
a clock generating device connected to the circuit board;
a quartz oscillator connected to the circuit board and the input device;
a CPU connected to the circuit board, the clock generating device, the quartz oscillator, and the display device; and
a memory connected to the circuit board and the CPU.

2. The time zone setting watch as claimed in claim 1, wherein the input device includes a option button, an adjust button, and a confirm button on the surface of the watch.
